(19) United States
(12) Patent Application Publication
(10) Pub. No.: US 2025/0344026 A1
(43) Pub. Date: Nov. 6, 2025

(54) Personalized Acoustic Feedback Management

(71) Applicant: Apple Inc., Cupertino, CA (US)

(72) Inventors: Caleb Rau, San Francisco, CA (US); Mary-Ann Rau, San Francisco, CA (US)

(21) Appl. No.: 19/094,554

(22) Filed: Mar. 28, 2025

Related U.S. Application Data
(60) Provisional application No. 63/641,113, filed on May 1, 2024.

(51) Int. Cl. H04R 25/00; H04R 1/10

(52) U.S. Cl. CPC H04R 25/453; H04R 1/1041; H04R 25/505; H04R 2430/01

(57) ABSTRACT

Acoustic feedback management systems, devices and methods are described. In an aspect, an audio device may analyze a hearing profile of a user to incorporate the hearing profile into various feedback management techniques (e.g., decorrelation techniques, adaptive feedback cancellation techniques, etc.) to personalize the management of acoustic feedback for the audio device.

### RELATED APPLICATIONS

This application claims the benefit of priority of U.S. Provisional Application No. 63/641,113, filed May 1, 2024, which is herein incorporated by reference.

### BACKGROUND

### Field

Aspects of the disclosure here relate to digital audio signal processing techniques for improving how ambient sound is reproduced by an audio device, such as a headphone or earphone/earbud. Other aspects are also described.

### Background Information

Consumer electronic devices referred to as audio devices, such as headphones and mobile phone handsets, are used in a variety of settings. Such devices typically include a microphone that receives an acoustic signal of the ambient sound and a speaker that reproduces that ambient sound into the ear of a user, following some electronic processing of the microphone signal.

### SUMMARY

Acoustic feedback management systems, devices and methods are described. In an aspect, an acoustic feedback management system receives a microphone signal, applies a gain to the microphone signal based on a hearing profile (e.g., audiogram) of a user, and applies feedback management when a correlation between the applied gain and a feedback path attenuation signal exceeds a feedback threshold. In some instances, the feedback management applied includes decorrelation techniques. In other instances, the feedback management applied includes adaptive feedback cancellation techniques. In another aspect, such feedback management systems and methods may be performed on an audio device.

### BRIEF DESCRIPTION OF THE DRAWINGS

FIG. 1A shows an example audio device in accordance with an aspect.

FIG. 1B is a schematic illustration of an example audio device in accordance with an aspect.

FIG. 2 is a graphical representation of an example hearing profile in accordance with an aspect.

FIG. 3 is a feedback loop diagram in accordance with an aspect.

FIG. 4 is a flow chart of a method for managing acoustic feedback based on a hearing profile of a user in accordance with an aspect.

### DETAILED DESCRIPTION

It has been observed that acoustic instability in audio devices may lead to acoustic feedback (e.g., howling). In some instances, acoustic instability may occur when the audio device is in a stable state. In other instances, acoustic instability may occur when the audio device is in a dynamic state, such as when objects come closer to the speaker/microphone (e.g., a hand adjusting the fit of the device), the seal/acoustic leak between the audio device and the user's ear becomes larger (e.g., upon insertion/removal of the device), etc. In such instances, the speaker output and microphone input may become highly correlated. Conventional methods have utilized various techniques to address acoustic feedback (e.g., decorrelation, adaptive feedback cancellation, etc.). In one example, conventional decorrelation techniques decorrelate the speaker output and the microphone input signals to reduce the risk of acoustic feedback before it occurs, such as performing a frequency shift of the audio signal being sent to the speaker, adding a delay to the audio signal so that it becomes misaligned with the microphone signal, injecting noise into the speaker path (e.g., noise injection), etc. In another example, conventional adaptive feedback cancellation techniques cancel acoustic feedback that may have already occurred by estimating a filter to attenuate the feedback and then applying the filter to remove the feedback without removing the rest of the signal. However, it has been observed that such techniques may result in the degradation of audio quality and/or the introduction of audible artifacts. In particular, with regard to noise injection, it has been observed that the degree of noise injection necessary to cause a decorrelating effect may also yield a perceptible signal distortion for the user.

In accordance with aspects, an acoustic feedback management (“AFM”) system manages acoustic feedback by incorporating a hearing profile of the user into the various techniques utilized to address acoustic feedback. For example, the AFM system may analyze the hearing profile of the user (e.g. audiogram) to determine a detection threshold for each frequency band in the hearing profile, where sounds above the detection threshold may be audible to the user and sounds below the threshold may be inaudible to the user. Further, in one aspect where decorrelation techniques may be utilized to prevent acoustic feedback, the decorrelation techniques (e.g., noise injection, etc.) may be “tailored” to the detection threshold so that the decorrelation techniques are not audible to the user. In an aspect where adaptive feedback cancellation techniques are utilized to cancel acoustic feedback, the shape of a filter may be informed by a hearing profile of the user so that the AFM system can prioritize attenuation in regions of the hearing profile where there is more gain and where the user has more hearing loss so that the adaptive feedback cancellation techniques may be inaudible or less noticeable to the user. By personalizing the methods utilized to manage acoustic feedback (e.g., decorrelation techniques, adaptive feedback cancellation techniques, etc.), the AFM system not only avoids the drawbacks of conventional techniques (e.g., audio quality degradation, audible artifacts, etc.), but also allows for more aggressive feedback management techniques and therefore more aggressive gains to be applied, which may result in increased hearing coverage (e.g., 5-10 dB of additional amplification).

In various aspects, description is made with reference to figures. However, certain aspects may be practiced without one or more of these specific details, or in combination with other known methods and configurations. In the following description, numerous specific details are set forth, such as specific configurations, dimensions and processes, etc., in order to provide a thorough understanding of the aspects. In other instances, well-known digital audio signal processing techniques processes have not been described in particular detail in order to not unnecessarily obscure the aspects. Reference throughout this specification to “one aspect” means that a particular feature, structure, configuration, or characteristic described in connection with the aspect is included in at least one aspect. Thus, the appearances of the phrase “in one aspect” in various places throughout this specification are not necessarily referring to the same aspect. Furthermore, the particular features, structures, configurations, or characteristics may be combined in any suitable manner in one or more aspects.

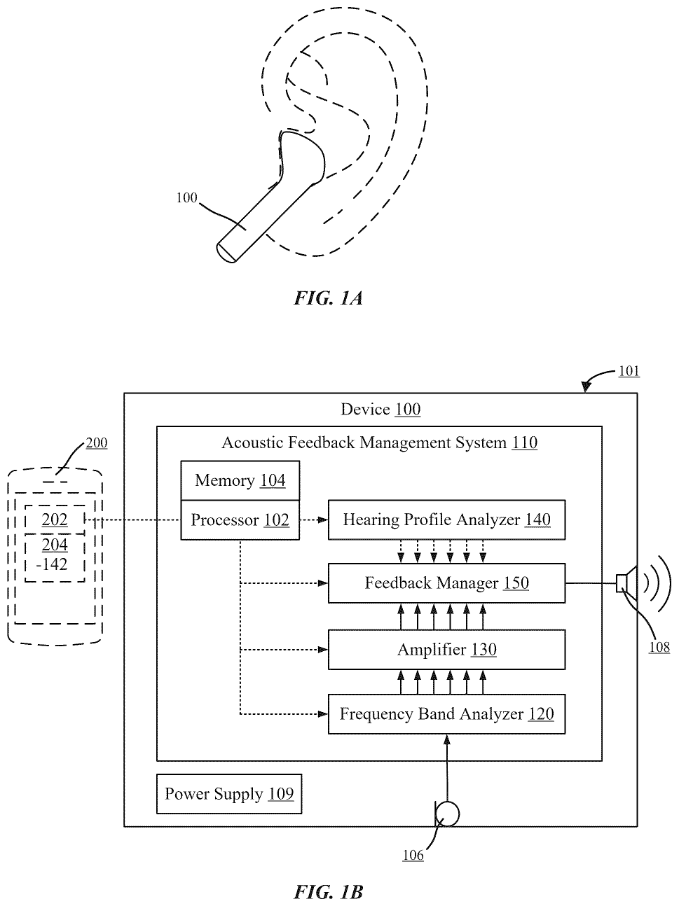

Referring now to FIG. 1A, an example audio device 100 is shown. Such audio devices may include any type of headphone (e.g. over-ear, on-ear, against-the-ear, earphone, earbud (e.g., outer ear, in-ear, etc.), headset, hearing aid, etc., which may be implemented as part of the AFM system either individually (e.g., one ear) or as a pair (e.g., both ears). In the example of FIG. 1A, audio device 100 (herein “device”) is an in-ear earbud in the left ear of a user.

Referring now to FIG. 1B, a schematic illustration of an example device is shown. Device 100 may include AFM system 110, which may be implemented using hardware, firmware and/or software. For example, device 100 may include one or more processors (e.g., central processing unit, etc.) coupled to a memory (e.g., read-only memory, random access memory, etc.) where the one or more processors may execute a set of instructions stored on the memory. In addition, the one or more processors may include networking technology to enable wireless communication (e.g., Bluetooth, etc.) between device 100 and an external device or computer system (e.g., mobile device, tablet, etc.). In the example of FIG. 1B, device 100 includes processor 102 that may execute a set of instructions stored on memory 104, where processor 102 may include networking technology to enable wireless communication with processor 202 of mobile device 200. Further, device 100 may include microphone 106 configured to receive ambient sound from the environment of the user, and speaker 108 configured to produce sound into an ear of the user. Device 100 may also include power supply 109 (e.g., lithium-ion battery, etc.) to provide power to the components of device 100, where such components may be housed in housing 101.

AFM system 110 may include frequency band analyzer 120, amplifier 130, hearing profile analyzer 140, and feedback manager 150. In some aspects, AFM system 110 may be implemented in whole or in part on an external device (e.g., mobile device, tablet, etc.), such that the operations of hearing profile analyzer 140 may be performed on a mobile device and the operations of feedback manager 150 may be performed on device 100, for example. In other aspects, AFM system 110 may be implemented in whole or in part on device 100. In the example of FIG. 1B, AFM system 110 is implemented on device 100, such that the operations of AFM system 110 may be performed on the earbud itself.

Frequency band analyzer 120 analyzes the ambient sound in an environment by parsing the microphone signal into frequency bands or sub-bands. For example, the frequency band analyzer (e.g., spectrum analyzer) may receive an input signal from a microphone and perform a frequency analysis on the input signal, where the magnitude of the input signal may be measured across multiple frequency bands or sub-bands. In the example of FIG. 1A, processor 102 may execute a set of instructions stored on memory 104 to cause frequency band analyzer 120 to parse the input signal from microphone 106 to measure the magnitude of the input signal across multiple frequency bands, which may then be sent to amplifier 130 as indicated by the arrows from frequency band analyzer 120 to amplifier 130.

Amplifier 130 may determine the amount of gain or amplification that may be needed to boost each frequency band of the microphone signal. In one aspect, the amount of gain relates to a degree of hearing loss for the user. For example, where the user has a high degree of hearing loss, more gain may be applied. In another aspect, the amount of gain relates to the amount of noise in the environment. For example, as the environmental noise rises, less gain may be applied even where the user has a high degree of hearing loss. This may be due to the nonlinear nature of hearing loss where a user may have difficulty hearing quiet sounds in a loud environment but may still hear louder sounds in the same loud environment. As such, amplifier 130 may analyze the ambient noise in an environment based on the data provided by frequency band analyzer 120 (as described above). Further, amplifier 130 may analyze the degree of hearing loss by the user based, at least in part, on the hearing loss data provided by hearing profile analyzer 140.

Hearing profile analyzer 140 may analyze a hearing profile specific to a user. The hearing profile may include the results of a hearing test taken by the user and displayed in a graph or chart (e.g., audiogram) or any other suitable format (e.g., table, lists, etc.). In some aspects, the hearing profile may be stored on a memory of device 100 (e.g., memory 104), where a processor (e.g., processor 102) may execute instructions stored on the memory to send the hearing profile to hearing profile analyzer 140. In other aspects, the hearing profile may be stored on an external device or system (e.g., mobile device, tablet, etc.) and then sent to device 100 either periodically or in response to a request from a processor of device 100. In the example of FIG. 1B, hearing profile 142 is stored on memory 204 of mobile device 200. Further, mobile device 200 may include processor 202, where processor 202 includes networking technology to enable wireless communication (e.g., Bluetooth, etc.) between mobile device 200 and device 100. For example, processor 102 of device 100 may communicate with processor 202 of mobile device 200 to retrieve or otherwise receive hearing profile 142 from memory 204 of mobile device 200. In such instances, hearing profile 142 may then be stored on memory 104 of device 100, where updated hearing profiles may be subsequently provided to device 100 as they become available. Further, hearing profile analyzer 140 may determine a detection threshold for a user based on the user's hearing profile.

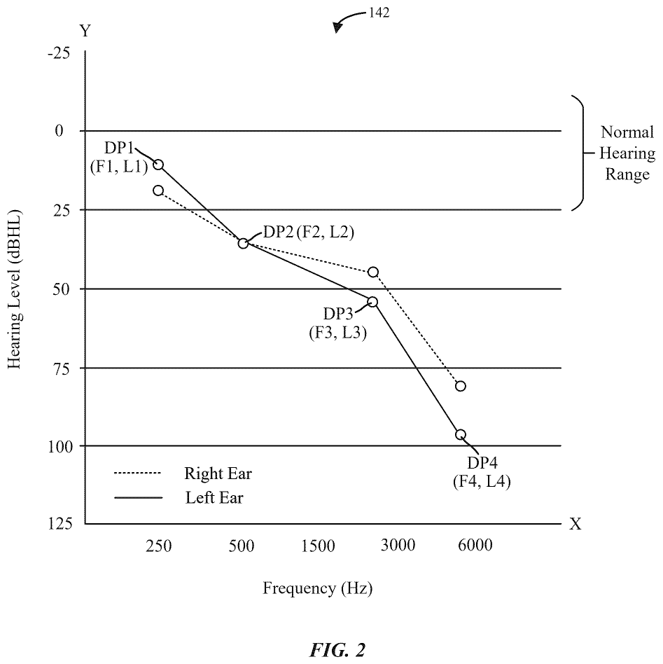

Referring now to FIG. 2, an example graphical representation of hearing profile 142 is shown. The graphical representation of hearing profile 142 (e.g., audiogram) plots the frequency/pitch (x-axis) versus the hearing level of the user (y-axis). As shown in FIG. 2, hearing profile 142 includes data related to both the right and left ear of a user. In the interest of clarity and conciseness, only data related to the left ear will be discussed. It should be noted, however, that AFM system 110 operates in the same personalized manner for both the right ear and the left ear based on their respective data sets so that the techniques engaged for the right ear may be different than the techniques engaged for the left ear in response to the same ambient noise environment. As shown in FIG. 2, each data point includes a frequency band and a corresponding hearing threshold. For example, hearing profile 142 includes data point 1 (DP1) at frequency F1 and hearing level L1, data point 2 (DP2) at frequency F2 and hearing level L2, data point 3 (DP3) at frequency F3 and hearing level L3, and data point 4 (DP4) at frequency F4 and hearing level L4. Further, the shape of the curve in the graphical representation of hearing profile 142 shows that the user has greater hearing loss at higher frequency ranges as compared to lower frequency ranges. In this way, hearing profile analyzer 140 may determine a detection threshold for the user at each frequency band, where sounds below the detection threshold for a particular frequency band may be inaudible and sounds above the detection threshold may be audible.

Referring back to FIG. 1B, hearing profile analyzer 140 may process hearing profile 142, where processing hearing profile 142 may include extracting and analyzing the hearing loss data of the user across the multiple frequency bands or sub-bands. In addition, hearing profile analyzer 140 may send such hearing loss data to amplifier 130 (and in parallel to feedback manager 150) as indicated by the arrows connecting hearing profile analyzer 140 and amplifier 130. Amplifier 130 may then compare the hearing loss data associated with hearing profile 142 sent from hearing profile analyzer 140 with the microphone signal data sent from frequency band analyzer 120. Based on the comparison, amplifier 130 may determine the different amounts of gain needed for each frequency band in the hearing profile of the user. In one example, where the user has a hearing profile similar to hearing profile 142 illustrated in FIG. 2, amplifier 130 may provide more gain in the higher frequency ranges due to the greater amount of hearing loss in the higher frequency ranges. Amplifier 130 may then apply the determined gains to the microphone signal to generate an adjusted microphone signal for each frequency band, where such gains may be limited or capped by a maximum possible gain that may render the device unstable (e.g., maximum stable gain, maximum feedback-free gain, etc.). Further, processor 102 may cause such data from amplifier 130 (e.g., determined gains, applied gains, etc.) to be shared with feedback manager 150.

Feedback manager 150 may analyze data from amplifier 130 and hearing profile analyzer 140 (both subsystems having incorporated the hearing profile of the user in their respective analyses) to perform feedback management operations related to device 100. As utilized herein, feedback management may include feedback mitigation, cancellation, decorrelation, or any other suitable method for managing the effects of acoustic feedback (e.g., decorrelation techniques, feedback cancellation techniques, etc.). It has been observed that acoustic feedback may occur in a stable state or a dynamic state. In the stable state, acoustic feedback may occur due to hearing aid or user characteristics where, for example, the applied gain exceeds a maximum stable gain for the device. In the dynamic state, the device may experience acoustic instability due to abrupt changes in the acoustic environment where, for example, the user adjusts the device and sound leaks from the speaker to the microphone (e.g., acoustic leakage). In such aspects, whether the acoustic instability rises to the level of acoustic feedback (e.g., howling) is based at least in part on the feedback path between the microphone and the speaker.

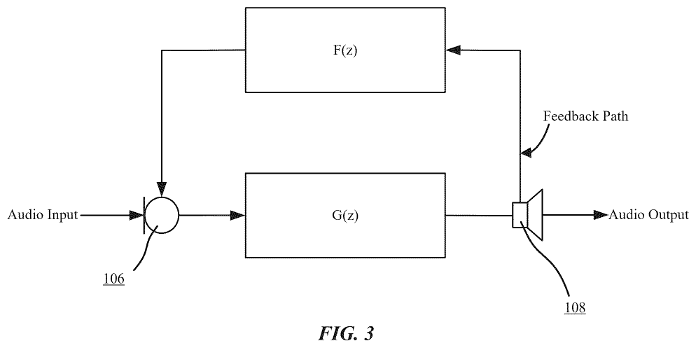

Referring now to FIG. 3, a diagram of an example feedback path (or feedback loop) from speaker 108 to microphone 106 is illustrated. In an aspect, the risk of acoustic feedback relates to the correlation between the applied gain and the attenuation of the signal between the speaker and the microphone along the feedback path. For example, in FIG. 3, if the attenuation of the amplified sounds from speaker 108 to microphone 106, F(z), is greater than the applied gain from microphone 106 to speaker 108, G(z), then acoustic feedback may not occur. Conversely, if the applied gain from microphone 106 to speaker 108, G(z), is greater than the attenuation of the amplified sounds from speaker 108 to microphone 106, F(z), then the residual signal from the feedback path may be amplified exponentially with each pass through the feedback path/loop to create an audible oscillation often associated with acoustic feedback. The correlation between these signals in the feedback path/loop may be summarized with an equation, such as equation (1) in which the conditions for acoustic stability may be satisfied:

$$\vert F ( z ) G ( z ) \vert < 1 \qquad ( 1 )$$

For example, if F(z) is −35 dB, then G(z) must be less than 35 dB to avoid acoustic feedback. In aspects, the threshold at which the correlation between F(z) and G(z) causes acoustic feedback may be referred to as the feedback threshold.

Feedback manager 150 may determine whether device 100 exceeds a feedback threshold in a stable state (e.g., maximum stable gain exceeded), a dynamic state (e.g., applied gain exceeds the feedback path attenuation) or any combination thereof, where such feedback thresholds may be frequency dependent so that each frequency band may have a particular feedback threshold. In instances where device 100 does not exceed the feedback threshold for a particular frequency band, the user may be at low risk for acoustic feedback in that particular frequency band. In instances where device 100 exceeds the feedback threshold for a particular frequency band, the user may be at high risk for acoustic feedback (e.g., howling, etc.) in that particular frequency band. Referring back to hearing profile 142 in FIG. 2, for data point 3, feedback manager 150 may determine that device 100 does not exceed the feedback threshold at frequency F3 since hearing level L3 at frequency F3 is near the normal hearing range and may only require minimal gain, where such minimal gain may not exceed the maximum stable gain in a stable state or may not be greater than the feedback path attenuation in a dynamic state. In such instances, the user may be at low risk for acoustic feedback. Conversely, for data point 4, feedback manager 150 may determine that device 100 exceeds the feedback threshold at frequency F4 since hearing level L4 at frequency F4 is far from the normal hearing range and may require significant gain, where such significant gain may exceed the maximum stable gain in a stable state or may be greater than the feedback path attenuation in a dynamic state. In such instances, the user may be at high risk for acoustic feedback. As described above, in such instances, feedback manager 150 may perform any suitable operation for managing the effects of acoustic feedback, where such operations may incorporate or be informed by the hearing profile of a particular user. In some aspects, feedback manager 150 may temporarily reduce the gain applied by amplifier 130 in a particular frequency band(s) based on a hearing profile of the user. In other aspects, feedback manager 150 may engage in decorrelation techniques to prevent acoustic feedback from occurring where, for example, decorrelation techniques may be engaged below a detection threshold based on a hearing profile of the user. In other aspects still, feedback manager 150 may engage in acoustic feedback cancellation techniques to cancel or neutralize acoustic feedback that has already occurred where, for example, the shape of a filter may be tailored to the hearing profile of a user. It should be noted that the above-described feedback management methods are not exhaustive and that other feedback management methods are contemplated. One such feedback management method, decorrelation, is described in greater detail below.

Feedback manager 150 may engage decorrelation techniques based on a detection threshold of the user as determined by hearing profile analyzer 140 and/or supplemental audio signals (e.g., ambient noise masking, etc.) that may obscure the audibility of artifacts resulting from the decorrelation techniques. It has been observed that conventional approaches engage decorrelation techniques without incorporating the hearing profile of a user. For example, where noise injection is utilized as a decorrelation technique, conventional methods utilize broadband white noise that may span across multiple frequency bands and introduce artifacts into the speaker path that may be audible to the user. In aspects described, the hearing profile of the user may be utilized to “tailor” or “personalize” the decorrelation techniques applied by AFM system 110. In particular, hearing profile analyzer 140 may analyze the hearing profile of the user to determine a detection threshold (e.g., hearing level, decibel level, etc.) for each frequency band so that decorrelation techniques may be engaged below the detection threshold. For example, where a decibel level of a decorrelation technique to be applied (e.g., noise injection, etc.) is below the detection threshold for a particular frequency band, the decorrelation technique may be inaudible to the user. Conversely, where a decibel level of a decorrelation technique to be applied exceeds the detection threshold for a particular frequency band, the decorrelation technique may be audible to the user.

Further, based on the detection threshold determined by hearing profile analyzer 140, feedback manager 150 may determine whether to engage decorrelation techniques for each frequency band. For example, in FIG. 2, feedback manager 150 may determine that the detection threshold at frequency F4 may be set at hearing level L4 so a noise signal, for example, may be injected into the path of speaker 108, where a decibel level of the noise signal does not exceed the detection threshold at frequency F4. In such instances, the noise signal would be inaudible to the user. In another example, feedback manager 150 may determine that the detection threshold at frequency F3 may be set at hearing level L3 so a noise signal may be injected into the path of speaker 108, where the decibel level of the noise signal does not exceed the detection threshold at frequency F3. Further, the respective noise signals may be a narrowband noise signal, where the characteristics of the narrowband noise signals may be tailored or limited to a particular frequency band (e.g., frequency band F4, frequency band F3, etc.) and a particular decibel level (e.g., hearing level L4, hearing level L3, etc.) based on the hearing profile of the user. In this way, decorrelation techniques may be personalized or tailored to the hearing profile of a user so that such decorrelation techniques may be undetectable to the user.

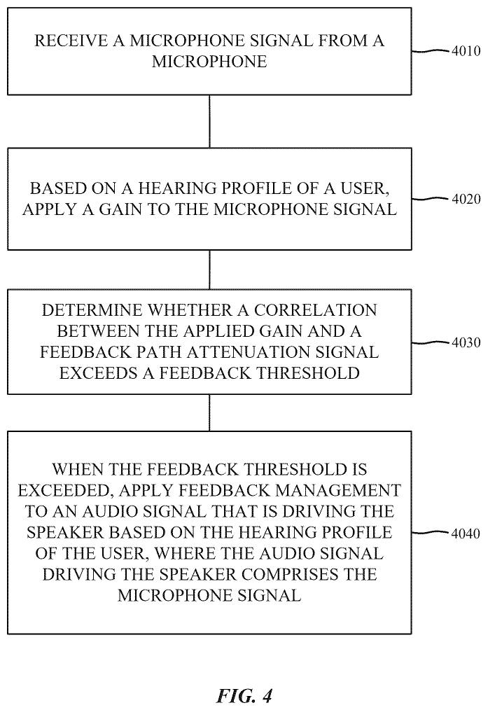

FIG. 4 is a flow chart of a method for managing acoustic feedback for an audio device based on the hearing profile of a user. In aspects, the method may be performed by a processor coupled to a memory, such as processor 102 and memory 104, or alternatively by a combination of a processor coupled to a memory as well as other electronic circuitry. At operation 4010 a microphone of device 100 (e.g. microphone 106) may receive an acoustic signal from the environment of the user, where the microphone may convert the acoustic signal into an electrical signal to be sent to frequency band analyzer 120. Frequency band analyzer 120 may parse the received microphone signal by determining the magnitude of the microphone signal across multiple frequency bands or sub-bands. Frequency band analyzer 120 may then send the parsed microphone signal to amplifier 130. At operation 4020 amplifier 130 may determine a gain to be applied to the microphone signal based on a hearing profile of the user. The hearing profile of the user (e.g., audiogram) may be retrieved from a memory of device 100 (e.g., memory 104) or from an external device (e.g., mobile device 200, etc.). The hearing profile may be processed by hearing profile analyzer 140, which may extract and analyze the hearing loss data for the user across multiple frequency bands or sub-bands in order to determine detection thresholds for the user at each frequency band. Hearing profile analyzer 140 may then send such data to amplifier 130. Amplifier 130 may compare the hearing loss data from the hearing profile sent by hearing profile analyzer 140 with the ambient noise data from microphone 106 sent by frequency band analyzer 120. Based on the comparison, amplifier 130 may determine the different gains required for the different frequency bands in the hearing profile of the user. Further, amplifier 130 may then apply the determined gains to the microphone signal to generate an adjusted microphone signal for each frequency band, where processor 102 may cause such data to be shared with feedback manager 150.

In further reference to FIG. 4, at operation 4030 feedback manager 150 may determine whether to apply feedback management techniques based on the hearing profile of the user. In some aspects, such as when acoustic feedback occurs in the static state, feedback manager 150 may decrease the applied gain so that the applied gain is below a maximum gain threshold for device 100. In other aspects, such as when acoustic feedback occurs in the dynamic state, feedback manager 150 may determine whether the correlation between the applied gain and the feedback path attenuation, such as the attenuation of the feedback path from speaker 108 to microphone 106 in FIG. 3 for example, exceeds a feedback threshold. In instances where the correlation between signals does not exceed the feedback threshold, feedback manager 150 may not apply feedback management methods to the audio signal driving the speaker. In instances where the correlation between signals exceeds the feedback threshold, feedback manager 150 (at operation 4040) may apply feedback management methods to the audio signal driving the speaker, where the audio signal driving the speaker includes the adjusted microphone signal. In some aspects, feedback manager 150 may engage in decorrelation techniques based on the hearing profile of the user. For example, where a noise signal is utilized as a decorrelation technique, the frequency band and decibel level of the noise signal may be limited to or tailored to a particular frequency band and a particular decibel level, so the noise signal is not audible to the user. In other aspects, feedback manager 150 may apply adaptive feedback cancellation techniques based on the hearing profile of the user. For example, where an adaptive filter is utilized to attenuate acoustic feedback, such an adaptive filter may be informed or shaped by the hearing profile of the user to be inaudible or less noticeable to the user.

In utilizing the various aspects of the aspects, it would become apparent to one skilled in the art that combinations or variations of the above aspects are possible for managing acoustic feedback based on a hearing profile of a user. Although the aspects have been described in language specific to structural features and/or methodological acts, it is to be understood that the appended claims are not necessarily limited to the specific features or acts described. The specific features and acts disclosed are instead to be understood as aspects of the claims useful for illustration.

What is claimed is:

1. An audio device comprising:
a microphone;
a speaker;
at least one processor coupled to the microphone and the speaker; and
a memory coupled to the at least one processor, the memory storing instructions that, when executed by the at least one processor, causes the device to perform operations that include:
receiving a microphone signal from the microphone;
applying a gain to the microphone signal to generate an adjusted microphone signal based on a hearing profile of a user,
determining whether a correlation between the applied gain and a feedback path attenuation signal exceeds a feedback threshold; and
when the feedback threshold is exceeded, applying feedback management to an audio signal that is driving the speaker based on the hearing profile of the user, wherein the audio signal driving the speaker comprises the adjusted microphone signal.

2. The device of claim 1, wherein the audio device is a headphone and the hearing profile comprises an audiogram.

3. The device of claim 1, wherein the feedback threshold is frequency dependent.

4. The device of claim 1, wherein applying feedback management includes engaging in decorrelation techniques, the decorrelation techniques including injecting a noise signal into the audio signal that is driving the speaker.

5. The device of claim 4, wherein a frequency band of the noise signal is limited to a frequency band where the correlation between the applied gain and the feedback path attenuation signal exceeds the feedback threshold.

6. The device of claim 5, wherein a decibel level of the noise signal is below a detection threshold so that the noise signal is inaudible to the user, the detection threshold being based on the hearing profile of the user.

7. The device of claim 1, wherein applying feedback management includes applying adaptive feedback cancellation techniques, the adaptive feedback cancellation techniques including applying a filter to the audio signal based on the hearing profile of the user.

8. An acoustic feedback management system for an audio device comprising:
a memory to store instructions; and
at least one processor to execute the instructions to:
receive a microphone signal from a microphone;
based on a hearing profile of a user, apply a gain to the microphone signal to generate an adjusted microphone signal;
determine whether a correlation between the applied gain and a feedback path attenuation signal exceeds a feedback threshold; and
when the feedback threshold is exceeded, apply feedback management to an audio signal that is driving a speaker based on the hearing profile of the user, wherein the audio signal driving the speaker comprises the adjusted microphone signal.

9. The system of claim 8, wherein the audio device is a headphone and the hearing profile comprises an audiogram.

10. The system of claim 8, wherein the feedback threshold is frequency dependent.

11. The system of claim 8, wherein the at least one processor executes the instructions to apply feedback management by engaging decorrelation techniques, the decorrelation techniques including injecting a noise signal into the audio signal that is driving the speaker.

12. The system of claim 11, wherein a frequency band of the noise signal is limited to a frequency band where the correlation between the applied gain and the feedback path attenuation signal exceeds the feedback threshold.

13. The system of claim 12, wherein a decibel level of the noise signal is below a detection threshold so that the noise signal is inaudible to the user, the detection threshold being based on the hearing profile of the user.

14. The system of claim 8, wherein the at least one processor executes the instructions to apply feedback management by applying adaptive feedback cancellation techniques, the adaptive feedback cancellation techniques including applying a filter to the audio signal based on the hearing profile of the user.

15. A method for managing acoustic feedback for an audio device comprising:
receiving a microphone signal from a microphone;
based on a hearing profile of a user, applying, by processing circuitry of the device, a gain to the microphone signal to generate an adjusted microphone signal;
determining, by the processing circuitry of the device, whether a correlation between the applied gain and a feedback path attenuation signal exceeds a feedback threshold; and
when the feedback threshold is exceeded, applying, by the processing circuitry of the device, feedback management to an audio signal that is driving a speaker based on the hearing profile of the user, wherein the audio signal driving the speaker comprises the adjusted microphone signal.

16. The method of claim 15, wherein the audio device is a headphone and the hearing profile comprises an audiogram.

17. The method of claim 15, wherein the feedback threshold is frequency dependent.

18. The method of claim 15, wherein applying feedback management includes engaging in decorrelation techniques, the decorrelation techniques including injecting a noise signal into the audio signal that is driving the speaker.

19. The method of claim 18, wherein a frequency band of the noise signal is limited to a frequency band where the correlation between the applied gain and the feedback path attenuation signal exceeds the feedback threshold.

20. The method of claim 19, wherein a decibel level of the noise signal is below a detection threshold so that the noise signal is inaudible to the user, the detection threshold being based on the hearing profile of the user.
